(19) United States
(12) Patent Application Publication
(10) Pub. No.: US 2006/0102206 A1
(43) Pub. Date: May 18, 2006

(54) Treatment solution injection system

(75) Inventors: David W. Wood, Maple Plain, MN (US); Kipp W. Knutson, Shorewood, MN (US)

Correspondence Address: NIKOLAI & MERSEREAU, P.A., 900 SECOND AVENUE SOUTH, SUITE 820, MINNEAPOLIS, MN, 55402, US

(73) Assignee: Nilfisk-Advance, Inc., Plymouth, MN (US)

(21) Appl. No.: 10/988,680

(22) Filed: Nov. 15, 2004

(51) Int. Cl. B08B 3/12; B08B 3/00

(52) U.S. Cl. 134/34; 134/184

(57) ABSTRACT

An onboard treatment solution injection system (40) includes a container (42) removably received in a holder (51) having a plurality of condition sensors (52) arranged in a vertical linear series. An injection pump (44) draws treatment solution from the container (42) and injects it into cleaning solution flowing in a line (15) from a solution tank (16) under action of a solution pump (18). The relative pumping rates of the pumps (18, 44) are controlled by a controller (58) controlled by the condition sensors (52) detecting a magnet (56) which is adjustably slideably mounted on the container (42) according to the type of treatment solution held therein. A valve (50) allows the injection pump (44) to be alternately in fluid communication with the container (42) or the solution tank (16) for purging.

### BACKGROUND

The present invention generally relates to chemical injection systems, particularly to chemical injection systems for surface cleaning equipment, and specifically to surface cleaning apparatus utilizing an onboard chemical injection system.

To enhance the cleaning ability of water and water-based cleaning solutions, treatment solutions such as but not limited to soaps, detergents, degreasers or the like are added to cleaning solutions before their application to the surface desired to be cleaned. To reduce weight and volume, treatment solutions are supplied in concentrated form to the user who typically adds the treatment solution to a greater volume of cleaning solution on site. One method of addition is simply for the user to dump in a measured amount of treatment solution into a desired amount of cleaning solution. However, for at least some applications, it is advantageous to add a metered amount of treatment solution into a flow of cleaning solution, whether that addition occurs in the cleaning equipment itself or before its introduction to the cleaning equipment. It should be appreciated that the ratio of treatment solution to cleaning solution will vary according to different suppliers and/or types of treatment solution. Errors often occur in the addition of treatment solution into the cleaning solution at the correct ratio due to haste, skill level and like factors. Also, it is often necessary to purge treatment solution from the addition system as different treatment solutions can react when combined, due to corrosive nature of many treatment solutions, and the like.

Thus, a need exists for systems which add treatment solution while overcoming the deficiencies in prior systems and are otherwise advantageous.

### SUMMARY

The present invention solves this need and other problems in the field of treatment solution injection systems by providing, in most preferred aspects, a plurality of condition sensors each providing an impulse and mounted relative to one of a holder and a container removably received therein. A controller controls operation of an injection pump in fluid communication with the container according to impulses received from the plurality of condition sensors receiving a physical stimulus from an element mounted on the other of the holder and the container.

In further aspects of the present invention, a valve allows an injection pump to be in fluid communication with a treatment solution container for injecting treatment solution into a flow of cleaning solution from a source or to be in exclusive fluid communication with the source of cleaning solution for purging the injection pump of the treatment solution.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic view of a floor surface cleaning apparatus utilizing an onboard chemical injection system according to the preferred teachings of the present invention.

FIG. 2 shows an exploded perspective view of a removable container for holding a treatment solution for use in the chemical injection system of FIG. 1.

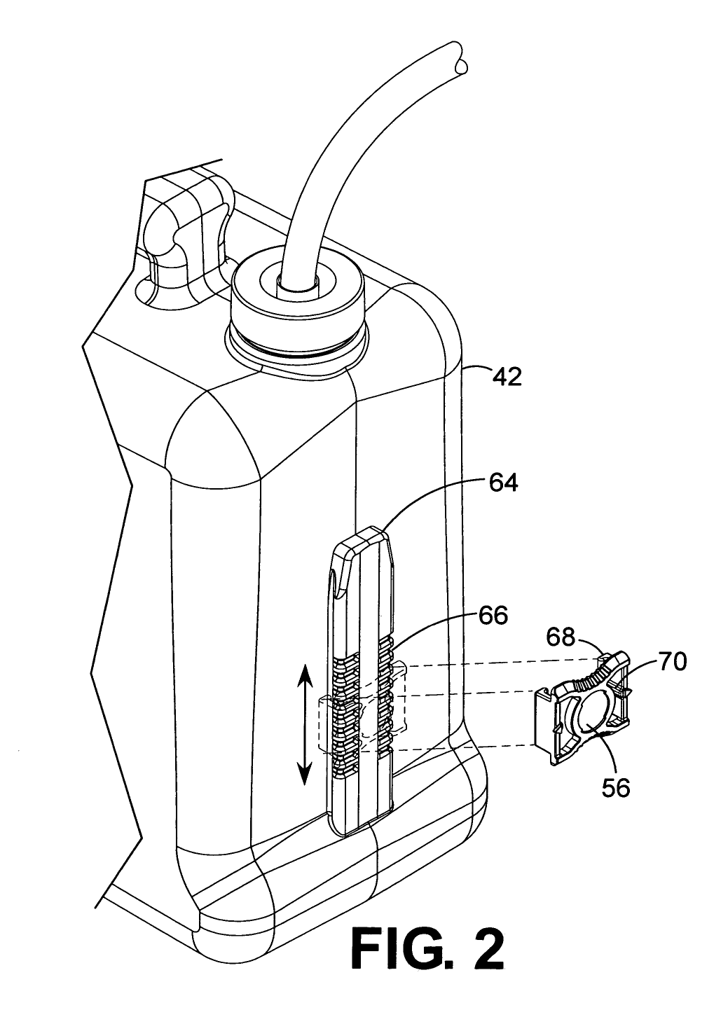

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “first”, “second”, “lower”, “side”, “horizontal”, “vertical”, and similar terms are used herein, it should be understood that these terms have reference only to the structure shown in the drawings as it would appear to a person viewing the drawings and are utilized only to facilitate describing the illustrative embodiment.

### DESCRIPTION

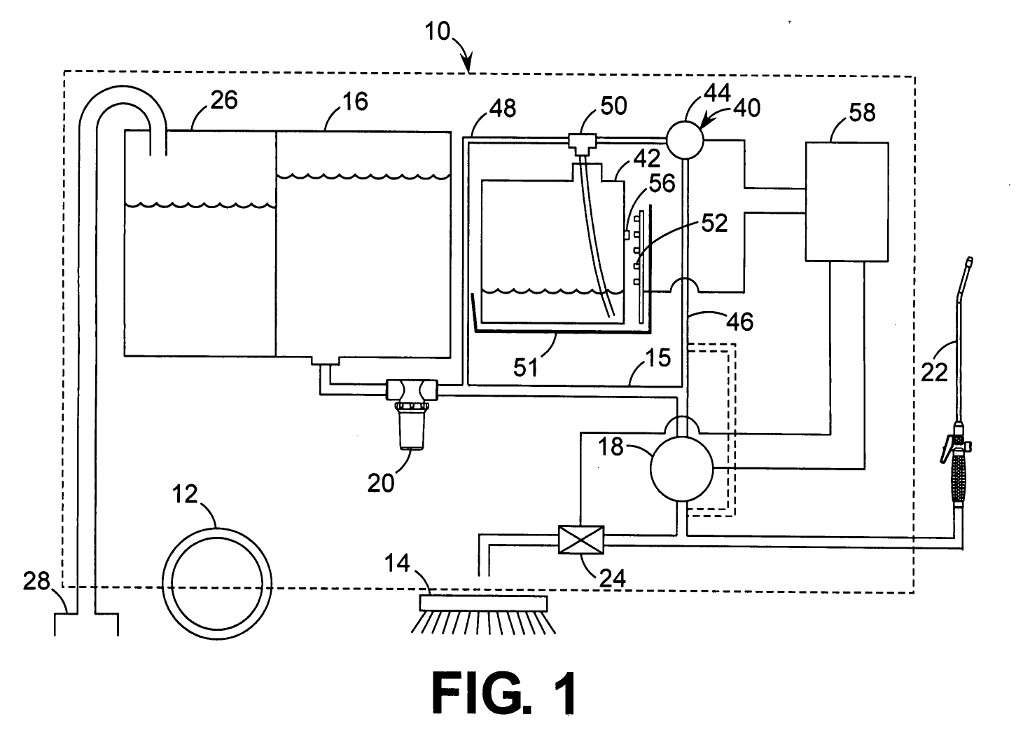

A surface cleaning apparatus such as a floor surface cleaning machine according to the preferred teachings of the present invention is diagrammatically shown in FIG. 1 and generally designated 10. In the preferred form shown, machine 10 is movably supported by three or more wheels, casters or the like 12 upon the surface to be cleaned, with one or more of the wheels, castors or the like 12 being driven if desired. The operator can either walk behind or ride upon machine 10 as desired. Machine 10 includes suitable elements 14 for agitating the surface to be cleaned such as rotatable disc brushes as diagrammatically shown. A cleaning solution such as but not limited to water and water-based premixed solutions is delivered via line 15 from a source of cleaning solution in the form of a solution tank 16 adjacent to the agitating elements 14 such as by a solution pump 18 in fluid communication with tank 16, with a filter 20 being provided between tank 16 and pump 18. In a preferred form, solution can be directed to surfaces spaced from machine 10 by a sprayer attachment 22, and a solenoid valve 24 is provided so solution can be delivered to either agitating elements 14 or sprayer attachment 22 as desired. In the preferred form, machine 10 includes a recovery tank 26 and a suitable vacuum system including a solution pickup element 28 such as squeegee as diagrammatically shown for collecting solution from the surface to be cleaned and delivering such collected solution to recovery tank 26.

Machine 10 as previously described can be of a variety of types and forms, and the present invention is not intended to be limited to any particular type or form including but not limited to the type or form shown and/or described.

According to the teachings of the present invention, machine 10 includes a treatment solution injection system 40 having a container 42 including an interior for holding a treatment solution to be added to the flow of cleaning solution in line 15, with such addition occurring before or after pump 18. In particular, injection system 40 includes an injection pump 44 in fluid communication with the interior of container 42 and with line 15 for creating flow of treatment solution from container 42 in a line 46 into the flow of cleaning solution from tank 16 in line 15.

In one aspect of the present invention, system 40 includes a purging system including a line 48 extending from line 15 after filter 20 and most preferably before solution pump 18 to line 46 before injection pump 44. Specifically, the interconnection of line 48 with line 46 is in the form of a valve 50 which alternately provides fluid communication of pump 44 with either tank 16 or container 42. Specifically, during cleaning operation, valve 50 in a first operational position or condition provides fluid communication with the interior of container 42 such that pump 44 creates flow of treatment solution from container 42 into the flow of cleaning solution in line 15. During purge operation, valve 50 in a second operational position or condition provides exclusive fluid communication with the source of cleaning solution in the preferred form of tank 16 such that pump 44 creates flow of cleaning solution from tank 16 into the flow of cleaning solution in line 15. The first operational condition of valve 50 is different than its second operational condition. Purging removes treatment solution from pump 44 to avoid corrosive concerns by the treatment solution. Further, purging removes treatment solution from pump 44 and line 46 to avoid reactions if different treatment solutions are desired to be injected by treatment solution injection system 40. In the most preferred form, line 46 is kept as short as possible to facilitate rapid purging when changing from one treatment solution to another.

In another aspect of the present invention, container 42 is removable from machine 10 to allow replacement or substitution of containers 42 holding different types of treatment solutions as desired to be applied to the surface. Specifically, container 42 is in the form of a bottle which can either be reusable intended for filling and refilling by the operator or can be a single use type in which the treatment solution is supplied. Container 42 is removably received such as by sliding into a container holder 51 in a manner to avoid container 42 from detrimentally moving as the result of movement of machine 10 and in preferred aspects to hold container 42 in an operationally consistent position relative to holder 51 and machine 10.

In a preferred form, system 40 includes a multiplicity of condition sensors 52 arranged in relation to container 42 received in holder 51. Sensors 52 are mounted in holder 51 in the form shown but could be mounted in other manners that maintain the desired positional relationship to container 42 received in holder 51. Sensors 52 are arranged at differing relative positions to container 42 received in holder 51 such as in a series in a linear manner. In the most preferred form shown, sensors 52 are arranged vertically along one side of container 42. However, it can be appreciated that sensors 52 can be arranged in different manners such as horizontally, in non-linear manners, and/or along multiple sides of container 42 according to the teachings of the present invention.

Associated with sensors 52, container 42 includes an element 56 which provides a physical stimulus to one or more of sensors 52. In the most preferred form, the physical stimulus is magnetism, with element 56 being in the form of a magnet and sensors 52 each being of the Hall Effect type which responds to magnetic fields. It can be appreciated that other types of elements 56 and sensors 52 can be utilized when the physical stimulus is magnetism. Although believed to be particularly advantageous as being easily isolated, easily sealed from surface debris, relatively economical, operationally dependable and the like, sensors 52 and element 56 can rely upon other types of physical stimulus including but not necessarily limited to light, pressure and even mechanical movement according to the teachings of the present invention. Although believed to be particularly advantageous that the element 56 does not require electric connection to machine 10, element 56 can be of other forms and types, and sensors 52 and element 56 could be mounted upon container 42 and machine 10, respectively, or in other mounting arrangements than shown and/or described.

Sensors 52 each transmit an impulse to a controller 58 of machine 10, with controller 58 controlling operation of pumps 18 and 44 according to the preferred teachings of the present invention. In particular, controller 58 relates the pumping rates of pumps 18 and 44 so that the desired ratio of treatment solution to cleaning solution exists. In turn, controller 58 is controlled by the impulse(s) received from sensors 52. As an example and with sensors 52 in a vertical arrangement, if the treatment solution in container 42 should be applied at a ratio of 1:32 to the cleaning solution, element 56 could be positioned at the same level as the lowest sensor 52, if the treatment solution in container 42 should be applied at a ratio of 1:128 to the cleaning solution, element 56 could be positioned at the same level as the second lowest sensor 52, and if the treatment solution in container 42 should be applied at a ratio of 1:64 to the cleaning solution, element 56 could be positioned intermediate the lowest and second lowest sensors 52. Also, system 40 could be set up that if element 56 is not sensed by any of sensors 52, a “standard” ratio of treatment solution to cleaning solution (such as 1:300) is applied.

Element 56 could be mounted at the factory at a single location on container 42 in the event that a particular container 42 is utilized for only one type of treatment solution such as in the case where container 42 is intended to be of a single use, disposable type or where container 42 is especially manufactured for a certain type of treatment solution such as being color coded or otherwise marked or identified for containing a certain type of treatment solution. However, in other aspects of the present invention, element 56 could be variably positioned on container 42 such as by being slideably mounted upon container 42. In the preferred form shown, a T-shaped rail 64 is integrally formed in the side of container 42 adjacent to sensors 52 when received in holder 51. The top and sides of rail 64 includes a series of recesses 66 at multiple sensing positions corresponding to sensors 52. In the most preferred form, recesses 66 are provided at locations corresponding to locations of each sensor 52 and also at locations intermediate adjacent sensors 52. A slide 68 is slideably mounted upon rail 64 and carries element 56. In a preferred form, element 56 is snap fit in a cavity formed in the backside of slide 68. In the most preferred form, slide 68 is generally C-shaped for slideable receipt on the top of rail 64 and includes detents 70 for removable receipt in one of recesses 66. In particular, slide 68 can be slid upon rail 64 between the multiple sensing positions to be at a position according to the particular ratio of application of treatment solution to cleaning solution desired and is prevented from unintentional movement relative to container 42 such as the result of operation of machine 10 by receipt of detents 70 into the recesses 66 at that position. It should be appreciated that although the particular manner of slideably mounting element 56 upon container 42 is believed to be advantageous, other manners of slideably mounting element 56 to container 42 will be available to a person skilled in the art. Likewise, although slideably mounting element 56 upon container 42 is believed advantageous such as avoiding the accidental loss of element 56, other manners of variably positioning element 56 upon container 42 will be available to a person skilled in the art such as but not limited to providing multiple cavities in container 42 which removably receives element 56.

Now that the basic construction and operation of machine 10 according to the teachings of the present invention have been explained, many extensions and variations will be obvious to one having ordinary skill in the art. For example, although machine 10 has been shown and described as including several inventive aspects and which is believed to produce synergistic results, machine 10 could be designed utilizing such inventive aspects singly or in other combinations according to the teachings of the present invention. As an example, machine 10 could utilize a purging system even though container 42 is not removable, sensors 52 and element 56 are not provided, or the like according to the teachings of the present invention.

Although disclosed in connection with a mobile floor surface cleaning machine 10, treatment injection system 40 according to the teachings of the present invention could be utilized in other types and forms of surface cleaning machines 10 which may include other forms of recovery systems such as wands or may not include a recovery system, may include other types of agitating elements 14 or may not include agitating elements, may be portable or stationary, may be useable in cleaning surfaces other than or in addition to floors or the like and/or could be utilized in other systems such as container or machine filling stations according to the teachings of the present invention.

In addition to operating pumps 18 and 44, controller 58 in response to impulse(s) received from condition sensors 52 can provide other operational functions including but not limited to providing visual indication to the operator of the type of treatment solution in system 40 according to the teachings of the present invention. Thus, the operator would be informed of the type of treatment solution being applied. In fact in circumstances where treatment solution is always supplied in concentrations where its application ratio to the cleaning solution is the same, controller 58 could provide such other operational functions without varying the pumping rates of pumps 18 and 44.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Treatment solution injection system comprising, in combination: a holder; a container having an interior for holding treatment solution and removably received in the holder; a plurality of condition sensors each providing an impulse and mounted relative to one of the holder and the container; an element providing a physical stimulus to one or more of the plurality of condition sensors and mounted relative to the other of the holder and the container; an injection pump in fluid communication with the interior of the container; and a controller controlling operation of the injection pump, with the controller being controlled by the impulses received from the plurality of condition sensors.

2. The treatment solution injection system of claim 1 further comprising, in combination: a solution pump for pumping cleaning solution through a line from a source, with the injection pump being in fluid communication with the line, with the controller controlling operation of the solution pump to relate pumping rates of the injection pump and the solution pump.

3. The treatment solution injection system of claim 2 wherein the element is a magnet and the plurality of condition sensors detect the presence of a magnetic field.

4. The treatment solution injection system of claim 2 with the element mounted on the container and the plurality of condition sensors mounted relative to the holder.

5. The treatment solution injection system of claim 4 with the plurality of condition sensors being mounted in a linear series, with the linear series being vertical.

6. The treatment solution injection system of claim 4 with the element being variably positioned at multiple sensing positions on the container.

7. The treatment solution injection system of claim 6 with the element being slideably mounted on the container for slideable movement between the multiple sensing positions, with the container including a rail, with the element being mounted upon a slide slideably received on the rail, with the rail including a plurality of recesses corresponding to the plurality of sensors, with the slide including a detent for removeable receipt in one of the plurality of recesses.

8. The treatment solution injection system of claim 2 further comprising, in combination: elements agitating a surface to be cleaned, with the cleaning solution and the treatment solution being delivered adjacent to the agitating elements; and a vacuum system for collecting solutions from the surface.

9. The treatment solution injection system of claim 2 further comprising, in combination: a purging system including a valve for providing fluid communication with the interior of the container and exclusive fluid communication with the source of cleaning solution.

10. The treatment solution injection system of claim 1 with the element being variably positioned at multiple sensing positions on the container.

11. The treatment solution injection system of claim 10 with the element being slideably mounted on the container for slideable movement between the multiple sensing positions, with the container including a rail, with the element being mounted upon a slide slideably received on the rail, with the rail including a plurality of recesses corresponding to the plurality of sensors, with the slide including a detent for removeable receipt in one of the plurality of recesses.

12. The treatment solution injection system of claim 1 wherein the element is a magnet and the plurality of condition sensors detect the presence of a magnetic field.

13. The treatment solution injection system of claim 1 with the element mounted on the container and the plurality of condition sensors mounted relative to the holder.

14. The treatment solution injection system of claim 1 further comprising, in combination: elements agitating a surface to be cleaned, with the cleaning solution and the treatment solution being delivered adjacent to the agitating elements; and a vacuum system for collecting solutions from the surface.

15. The treatment solution injection system of claim 1 further comprising, in combination: a purging system including a valve for providing fluid communication with the interior of the container and exclusive fluid communication with the source of cleaning solution.

16. Treatment solution injection system comprising, in combination: a container having an interior for holding treatment solution; an injection pump in fluid communication with the interior of the container; a solution pump for pumping cleaning solution through a line from a source, with the injection pump being in fluid communication with the line; and a purging system including a valve for providing fluid communication with the interior of the container and exclusive fluid communication with the source of cleaning solution.

17. The treatment solution injection system of claim 16 further comprising, in combination: a controller controlling operation of the injection pump and the solution pump to relate pumping rates of the injection pump and the solution pump.

18. Method comprising:
flowing a cleaning solution from a source;
providing a source of treatment solution;
operating an injection pump in a first condition in fluid communication with the source of treatment solution for injecting the treatment solution into the flow of cleaning solution; and
operating the injection pump in a second condition in exclusive fluid communication with the source of cleaning solution for injection the cleaning solution into the flow of cleaning solution to purge the injection pump, with the second condition being different than the first condition.

19. The method of claim 18 further comprising:
agitating a surface to be cleaned; and
directing the flow of cleaning solution with the treatment solution injected therein adjacent to the agitation for agitating the cleaning and treatment solutions on the surface to be cleaned.
